(19) United States
(12) Patent Application Publication
(10) Pub. No.: US 2018/0370409 A1
(43) Pub. Date: Dec. 27, 2018

(54) APPARATUS AND METHOD FOR LOADING A TRUCK

(71) Applicant: RJ Product Designs, Lethbridge (CA)

(72) Inventors: Russell Wayne Olson, Frontier (CA); John Van Deurzen, Lethbridge (CA)

(21) Appl. No.: 15/982,819

(22) Filed: May 17, 2018

Related U.S. Application Data
(60) Provisional application No. 62/508,148, filed on May 18, 2017.

(30) Foreign Application Priority Data
May 18, 2017 (CA) 2967605

(51) Int. Cl. B60P 1/44; B60P 1/00; B60P 3/07

(52) U.S. Cl. CPC B60P 1/4407; B60P 1/4492; B60P 1/4478; B60P 3/07; B60P 1/003

(57) ABSTRACT

A loader to load cargo onto the bed of a truck includes a frame having a rear roller, and a winch mountable onto the bed of the truck, and a platform having forward and rear wheels depending downwardly from corresponding front and rear ends thereof. The roller may include a cable guide formed circumferentially around the roller. A winch cable is selectively extendable from the winch over the cable guide on the rear roller, and to attach to the front end of the platform when in it's lowered pre-hoisting position. The front end of the platform is hoistable from its pre-hoisting position onto the rear roller where-upon continued winching-in of the cable onto the winch draws the rest of the platform over the rear roller so as to rest on the top of the frame. The platform is then winched to the front of the frame.

### CROSS REFERENCE TO RELATED APPLICATIONS

This Application claims priority from U.S. Provisional Patent Application No. 62/508,148, filed on May 18, 2017. entitled “APPARATUS AND METHOD FOR LOADING A TRUCK” and Canadian Patent Application No. 2,967,605, filed on May 18, 2017, entitled “APPARATUS AND METHOD FOR LOADING A TRUCK”, entireties of which are incorporated herein by reference.

### FIELD OF THE INVENTION

This invention relates to the field of cargo lifting devices, and in particular, to an apparatus and corresponding method for loading cargo onto a truck bed.

### BACKGROUND

In the prior art, the applicant is aware of the following patents and published patent applications:

U.S. Pat. No. 5,934,863, which issued on Aug. 10, 1999, to Gregory S. Beck, entitled “Vehicle Loading and Unloading Apparatus and Method”. Beck discloses a personal vehicle loading and unloading apparatus which includes a support structure mounted to a platform such as a truck bed which supports the personal vehicle, and a moveable ramp mounted telescopically within the support structure. The ramp is manually moveable between a retracted position where substantially the entire ramp is within the truck bed and an extended position where substantially the entire ramp extends from the truck bed. The ramp and the support structure each have an upper surface over which the bottom surface of the personal vehicle, or a conveyor for the vehicle, rides as the personal vehicle is moved to and from the truck bed. A winch mechanism mounted to the support structure pulls the personal vehicle into the truck bed during loading and slowly lowers the personal vehicle from the truck bed during unloading.

U.S. Pat. No. 6,089,816, which issued on Jul. 18, 2000, to Duane J. Christ, entitled: “Article Load Apparatus”. Christ discloses an article load apparatus for loading and unloading articles, particularly motorized vehicles, onto a load carrying surface of another vehicle. The article load apparatus includes a mobile cart having a base for carrying an article. A power drive is mountable on the vehicle for moving the cart between a first position on the load carrying surface of the vehicle and a second position displaced from the load carrying surface. The cart is releasably lockable to a support member on the vehicle. A channel member is carried on the base for guiding and supporting an article. Tie down members on the base receive straps for securing an article to the cart. A chock is optionally mounted on the base for receiving a wheel of a wheeled article. A support frame is mountable on the vehicle and carries an electric motor driven winch.

U.S. Pat. No. 6,705,820, which issued on Mar. 16, 2004, to Harold M. Schilling, entitled: “Carrier/Lift for a Truck bed”. Schilling discloses loading and unloading a small vehicle into a truck bed. A carrier/lift is adapted to be mounted in a truck bed. A carrying platform pivots and translates in a constrained manner along a pair of tracks to an inclined loading position for loading of the vehicle into the bed of the truck. A platform has a recess for storage of a pair of nestable loading ramps. The platform can be supported above the floor of a truck bed to provide usable storage space in the bed o f the truck between the platform, with the nested ramps stowed therein.

U.S. Pat. No. 7,544,027, which issued on Jun. 9, 2009 to James Barker, entitled: “System and Method for Loading Vehicles onto the Cargo Bed of a Transporting Vehicle”. Barker discloses loading one or more vehicles onto the cargo bed of a transporting vehicle such as a pickup truck or trailer. A support is located at the front of the cargo bed above the plane of the cargo bed. Ramps and the support are adapted to connect to and remove from each other such that the ramps are secured inside the cargo bed at an angle above the plane of the cargo bed of the transporting vehicle.

U.S. Pat. No. 7,997,850, which issued on Aug. 16, 2011 to Ronald G. Hutchison, entitled: “Small Vehicle Loading and Transport Deck for Pickup Trucks”. Hutchison discloses a small vehicle loading and transport deck for pickup trucks which includes a box-like frame which is positioned within the bed of the truck and which has a deck movably mounted thereon which is movable from an inclined and rearwardly extending loading/unloading position to a transport position wherein the deck is positioned on the top of the frame. The box-like frame provides a storage area beneath the deck so that articles or objects may be stored therein. A winch is provided for moving the deck between its loading/unloading position and its transport position and vice versa.

U.S. Pat. No. 9,227,544, which issued on Jan. 5, 2016, to Lawrence Rogge, entitled: “Vehicle Lifter”. Rogge discloses a vehicle lifter having (a) a floor, (b) a frame operably coupled to the floor, the frame having a support extending from one end of the frame to an opposite end of the frame, (c) a trolley frame located between the frame and the support, (d) a support bar capable of being coupled to a vehicle, (e) a hydraulic lifter operably coupled to the support bar and the trolley frame, (f) a wheel operably coupled to the trolley frame, (g) a winch operably coupled to the trolley frame, (h) a winch line operably coupled to the winch at one end and to the frame at another end, (i) a housing coupled to the trolley frame, (j) a hydraulic motor within the housing, and (k) a hydraulics container within the housing.

U.S. patent application Ser. No. 12/707,807, which was published on Aug. 18, 2011 under Publication No.: US 2011/0202199, which is the application of Steven Joseph Crane, entitled: “Cargo Loading and Unloading System for a Vehicle”. Crane discloses a cargo loading and unloading system which mounts to a vehicle's flat surface and is contained within the vehicle's constraints. The system includes a rolling platform attached to a tilting frame, which in turn pivots on top of a sliding extension frame, which in turn extends from a base frame. The extension frame is pushed toward the vehicle's rear. As the extension frame moves rearward, a tilt initiator lifts one end of the tilting frame from the flat surface, initiating tilting. The tilting frame continues to pivot upward about the vehicle's rear. The cargo platform rolls out or down to a loading or unloading surface. Once cargo is loaded or unloaded, the platform is raised back onto the tilting frame. The tilting frame pivots downwards towards the flat surface and lands on the extension frame. The extension frame is pulled back into the base frame.

### SUMMARY

The present invention may be characterized is one aspect as apparatus to load cargo onto the bed of a truck wherein the apparatus includes:

a frame mountable onto the bed of the truck,

a platform having forward and rear wheels depending from corresponding front and rear ends thereof,

a winch having a winch cable wherein the winch is mountable to the frame and the cable is extendable from the winch,

a rear roller mounted on a rear end of the frame, wherein the roller may advantageously include a cable guide formed circumferentially in and around a substantially centered position along a length of the roller,

wherein the platform is positionable into a pre-hoisting position, for example flush on the ground, at the rear of the frame so as to be aligned with the frame when the frame is mounted in the bed of the truck,

and wherein the winch cable is selectively extendable from the winch, over the cable guide on the rear roller, and to the front end of the platform when in the pre-hoisting position, wherein a distal end of the cable, distal from the winch, is removably mountable to the front end of the platform,

wherein the front end of the platform is hoistable upwardly from its pre-hoisting position so as to engage onto the rear roller where-upon continued winching-in of the cable onto the winch draws the rest of the platform over the rear roller as the front end of the platform is winched towards the front end of the frame,

wherein the platform and any cargo thereon have a center-of-gravity, and wherein the platform pivots over the roller acting as fulcrum, as the center-of-gravity is drawn over the roller past a balance point of the platform and cargo so that the platform pitches from an inclined-during-hoisting position to a horizontal and loaded position with the front wheels resting on the frame and the platform substantially completely on the frame.

In one embodiment, a rotating arm or guide arm (collectively referred to herein as a rotating arm) is rotatably mounted to the front end of the platform, preferably centered on the front end of the platform, and in any event located so as to align with the cable guide on the rear roller when the platform is being hoisted up onto the rear roller. The arm may be linear, and is rotatably mounted at its rear end to the front end of the platform, and is mounted at its forward end to the distal end of the cable. Thus, as the platform is being hoisted by the cable, the arm remains co-linear with the cable, and follows the cable through the cable guide when drawn up and onto the roller. This aligns the platform into its correct position on the rear roller so that the decking or sheeting of the platform fits snugly and evenly spaced between the sides or sidewalls of the truck bed.

Advantageously, the rear roller is reinforced or at least strong enough to resist bending due to the weight of the platform and its maximum weight of cargo acting through a force vector of varying direction and magnitude bearing down onto the rear roller. In one embodiment, a strengthening tube is journaled in left and right hollow sleeves forming the rear roller. The opposed facing ends of the sleeves are spaced apart along the strengthening tube by a width at least equal to the corresponding thickness of the arm so as to form a circumferential or annular channel or groove which mates with the rotating arm.

In one embodiment, the rear wheels on the platform extend rearwardly of the platform, for example on telescopic legs, so that, as the platform is inclined during hoisting, the rear of the platform which is still remaining in contact with the ground is free to translate forwardly as the front end of the platform is lifted. The length of the legs reduces the steepness of the platform during hoisting of the platform. The front wheels are mounted so that they are exposed downwardly enough to engage a lower most surface of the wheels with the top of the frame once the platform rotates over the rear roller from its inclined position during hoisting to its horizontal and loaded position.

The telescopic legs may be a laterally spaced apart pair of legs which slidingly translate rearwardly from, for example tubes or sleeves mounted in or under the platform. The legs may be pinned in their desired extended or retracted positions. Two or more telescopic legs are mounted to the platform for rearward telescopic extension. The telescopic legs have wheels or rollers mounted at their rearmost ends. The wheels or rollers may be mounted in mounting brackets which have a downwardly extending flange width at the leading end of the mounting bracket. The downwardly extending flange engages the ground when the platform has been positioned by the hoist so that an included angle between the platform and the ground is small; in the order of a few degrees, so as to act as a wheel brake or anchor.

In one preferred embodiment the platform is constructed of rigid sheeting or decking (collectively herein sheeting) overlaying a rigid sub-frame. The wheels may be mounted to the subframe; the front wheels recessed in a cut-out in the sheeting. Where the wheels are on the ends of telescopic legs, the legs are slidably mounted in receiver tubes wherein the tubes may be mounted to the subframe.

In a further preferred embodiment, a second roller is mounted at the front of the frame, and the winch cable passes over both the front and rear rollers during hoisting. The front roller may also advantageously include a cable guide centered over the winch.

### BRIEF DESCRIPTIONS OF THE DRAWINGS

FIG. 1, in perspective view, the platform and rear-end of the loading frame, with the platform in a lowered position ready for hoisting and the frame mounted in the bed of a pick-up truck

FIG. 2, is the view of FIG. 1, with the platform in an intermediate elevated position during hoisting.

FIG. 3, is the view of FIG. 2, with the platform hoisted onto the rear-roller of the frame so as to be near to its balance point on the roller.

FIG. 4 is the view of FIG. 3 with the platform fully loaded onto the frame.

FIG. 5, is in rear perspective view, showing the platform and frame of FIG. 1.

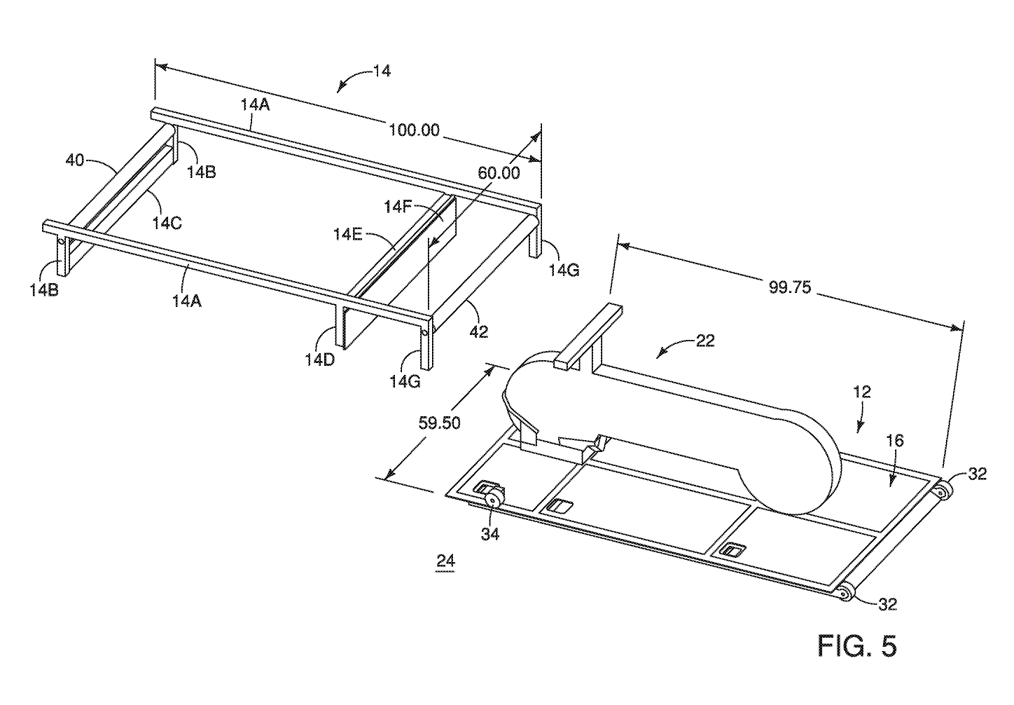

FIG. 6 is a front perspective view of FIG. 5.

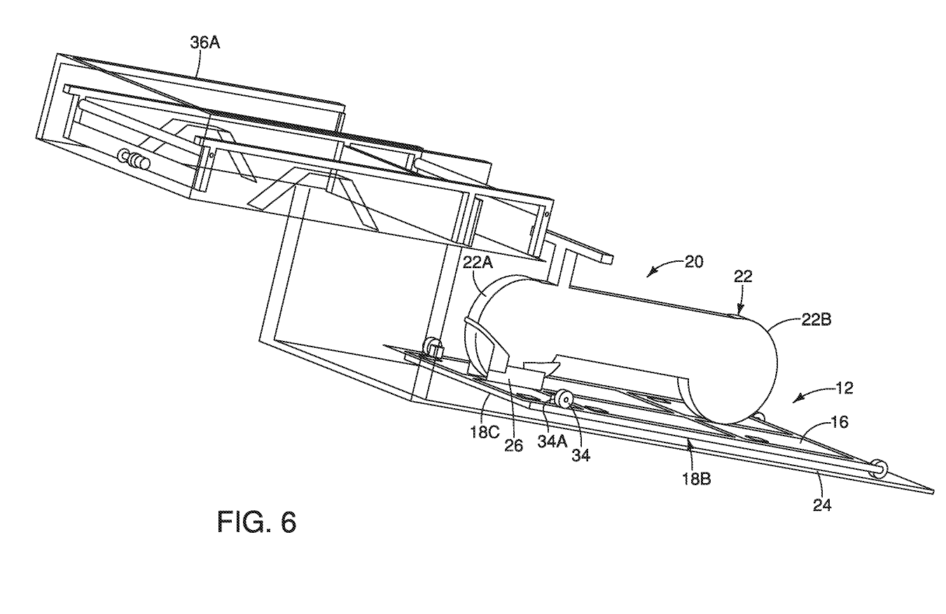

FIG. 7 is a rear perspective view of the platform and frame of FIG. 2.

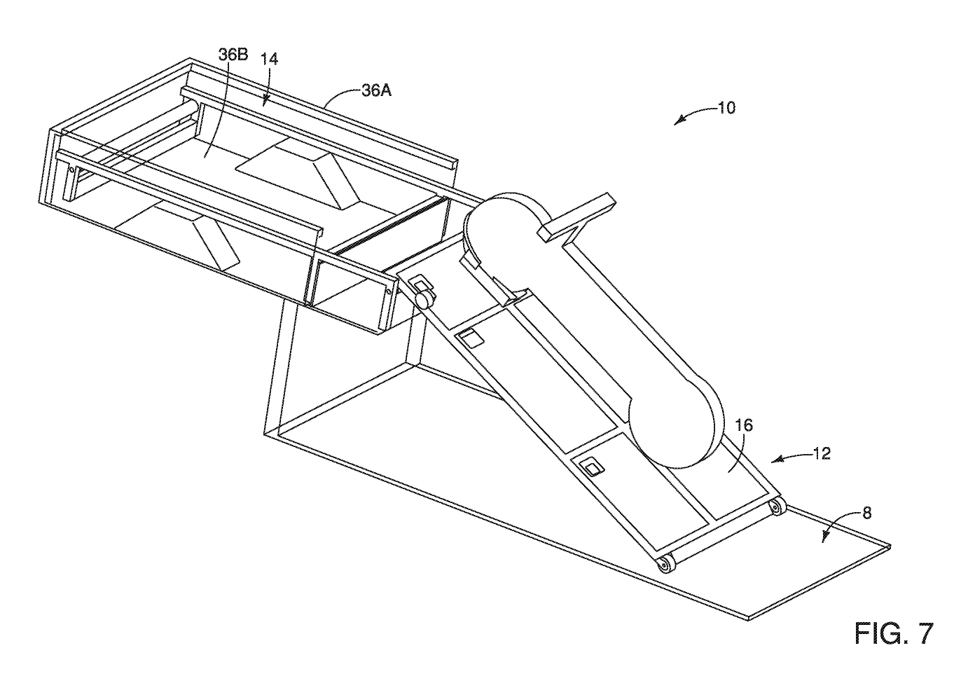

FIG. 8 is a front perspective view of FIG. 4.

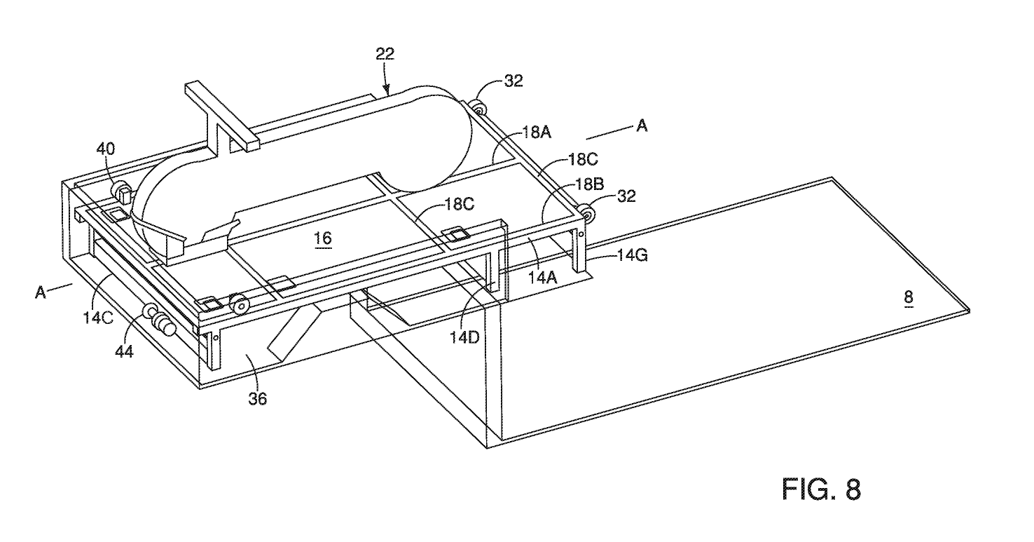

FIG. 9 is a rear perspective, partially cut-away, view of the front-end of the platform and rotating arm being pulled into engagement over the rear roller of the frame.

FIG. 10 the view of FIG. 9 with the rotating arm and front-end of the platform having been pulled over the roller.

FIG. 11 is, in partially cut away perspective view, a winch mounted to the front of the frame for tensioning the cable.

FIG. 12 is, in partially cut away rear perspective view, the front and rear rollers mounted onto the frame.

FIG. 12A is, in partially cutaway elevation view, the table guide of the rear roller.

FIG. 12B is the roller of FIG. 12A exploded to show the inner sleeve.

FIG. 12C is, in partially cut away side elevation view, a front platform roller mounted on the front end of the platform.

FIG. 13 is, in rear perspective view, an alternative top-loader embodiment of the loader described herein, shown in a partially hoisted position.

FIG. 14 is the top-loader embodiment of FIG. 13 in a fully hoisted position.

FIG. 15 is a partially cut-away perspective view of one of the pair of extendable legs telescopically mounted into the platform of the mid-loader embodiment of FIG. 4.

FIG. 16 is an enlarged, partially cut-away view of the roller and wheel brake end of the extendable leg of FIG. 15.

### DETAILED DESCRIPTION

In the accompanying figures wherein like part numbers represent corresponding parts in each view, and wherein lower case and upper case alphabetical reference numbers are equivalent, mid-loader 10 includes an elevateable rolling platform 12 which is elevateable so as to load onto, and off-load from, a frame 14. Platform 12 includes rigid sheeting 16 which overlays a subframe 18. Subframe 18 includes longitudinally extending stringers 18A (shown in dotted outline), side rails 18B, and laterally extending ribs 18C, which extend laterally across stringers 18A, so as to form a rigid subframe with ribs 18C.

Cargo 20, such as for example the illustrated motorcycle 22, are driven, rolled, or otherwise placed onto sheeting 16 when platform 12 is in its lowered position flush down onto the ground 8. In the case where cargo 20 is a motorcycle 22 or the like, a mounting bracket 26 may be used to support the front wheel 22A of motorcycle 22. The rear wheel 22B may be tethered down onto sheeting 16 by means of straps 28A attaching to mounting eyes 30 secured to subframe 18 through cutouts 16A in sheeting 16. Likewise, front wheel 22A may be secured down onto sheeting 16 by means of straps 28B attached to eyes 30 in cutouts 16B in sheeting 16.

Rear rollers or wheels 32 are mounted so as to extend downwardly and aft from subframe 18 to thereby protrude below and behind sheeting 16 of platform 12 when subframe 18 is angled upwardly during hoisting. Front rollers 34 are mounted to side rails 18B of subframe 18 by means of brackets 34A so as to position front rollers 34 in cutouts 16C in sheeting 16. Brackets 34A position rollers 34 so that most of each roller extends above the top surface of sheeting 16 leaving only the lower most roller surface 34B protruding beneath the lower surface of sheeting 16.

Front edge 16D, and side edges 16F of sheeting 16 extend outwardly beyond subframe 18. The extension of the edges of sheeting 16 cantilevered out over and beyond the outer edges of subframe 18 may be merely only an inch or two in the mid-loader embodiment, as explained better below, or may extend laterally further out, or subframe 18 and platform 12 may be wider laterally in a top-loader embodiment described below.

In the mid-loader embodiment, frame 14 is sized so as to snugly mount into the bed 36 of a pickup truck 38. In particular, side rails 14A of frame 14 extend along the length of truck bed 36 slightly laterally inset from the upper edges 36A of the side walls of bed 36. Vertical uprights support side rails 14A elevated above the lower surface 36B of bed 36. In particular, front uprights 14B support the forward ends of side rails 14A, and also support a cross member 14C extending there between. Uprights 14B also support a front roller 40 extending laterally across and between the upper ends of uprights 14B so that front roller 40 extends horizontally across to each of, and just below, side rails 14A.

Side rails 14A extend horizontally rearwardly from front uprights 14B, and are supported near the back of the truck bed 36 on intermediate uprights 14D. Intermediate uprights 14D support a cross member 14E therebetween, and may support a wall or door 14F, which acts to close off the space within the truck bed underneath side rails 14A.

Side rails 14A continue horizontally rearwardly over the tailgate in its lowered position, and are supported at their rear most ends on rear uprights 14G. Rear uprights 14G support rear roller 42 there between.

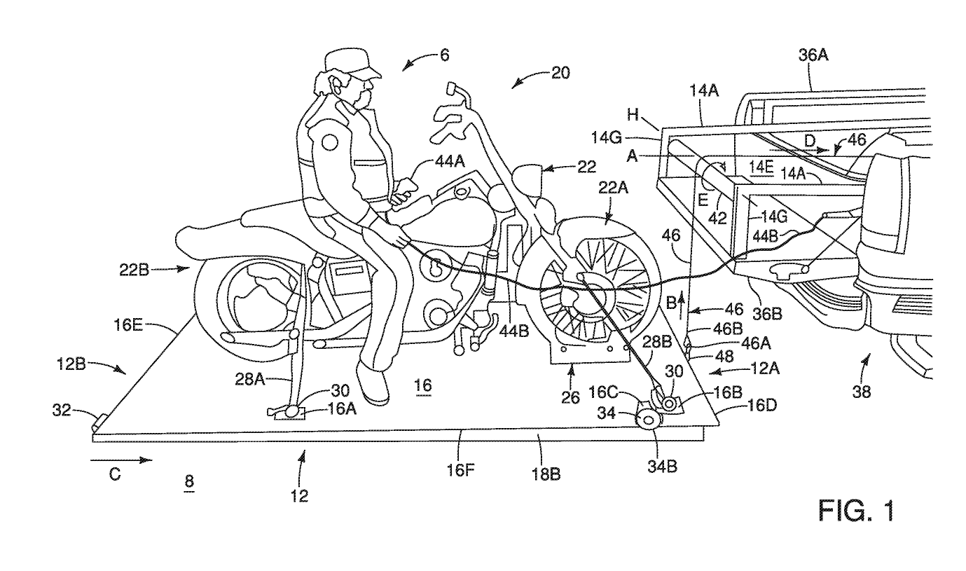

The required winch 44 may be mounted to cross member 14C, positioned on cross member 14C so that a winch cable 46 extending from winch 44 extends along the centerline or centroidal axis A of truck bed 36. Winch cable 46 extends upwardly from winch 44 so as to pass over front roller 40 and t hereafter extends rearwardly over truck bed 36 so as to pass over rear roller 42. When platform 12 is in its lower position as seen in FIG. 1, winch cable 46 extends rearwardly over rear roller 42, and from rear roller 42 extends downwardly to the front edge 16D of sheeting 16. A removable coupler 46A, such as a ring, or shackle, etc. connects the rear most end 46B of the winch cable to the front rib 18C of subframe 18.

In a preferred embodiment, a rotating rigid link or arm 48 (collectively herein an “arm”) is rotatably mounted at its rear end 48A to the front rib 18C of subframe 18. Front rib 18C is recessed under and behind the leading edge 16D of sheeting 16. Arm 48 is rotatably mounted at its front end 48B to coupler 46A of winch cable 46. The operation of rotating arm 48 is described below.

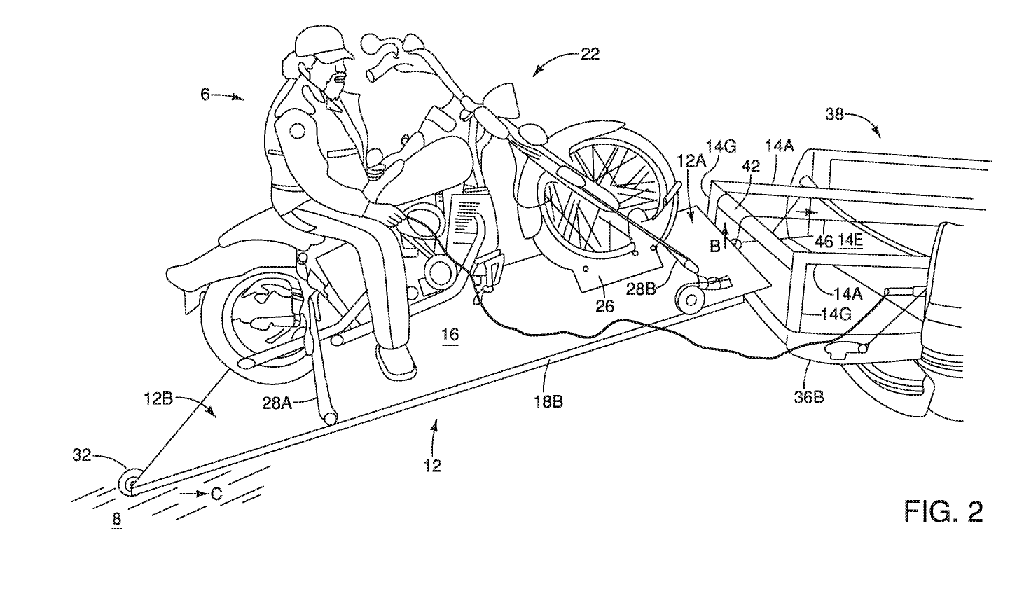

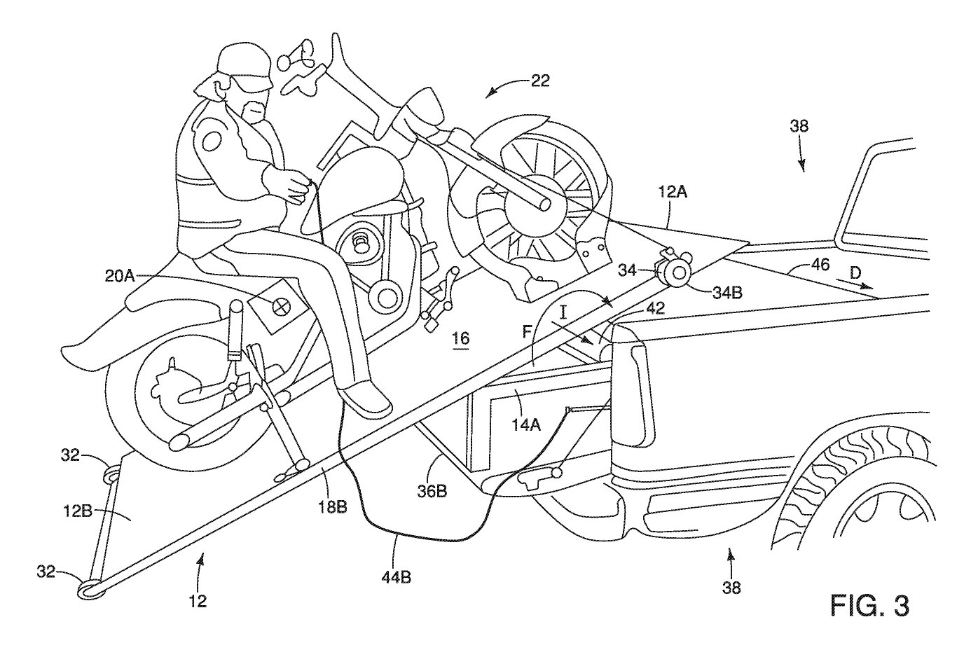

When it is desired to load platform 12 and its cargo 20 onto truck 38 so as to position platform 12 on top of frame 14 when frame 14 is mounted into truck bed 36, cable 46 is attached to front end 48B by coupler 46A and winch 44 is operated so as to tension winch cable 46 and thereby hoist the front end 12A of platform 12 upwardly in direction B. As the front end of platform 12 is hoisted upwardly in direction B, the rear end 12B of the platform 12 translates forwardly over the ground 8 in direction C, as better understood by viewing the hoisting sequence shown in FIGS. 1-3. Thus, as seen in FIG. 2, the front end 12A of platform 12, as it is hoisted in direction B by the tensioning of cable 46, is hoisted vertically upwards until the front end 12A is adjacent rear roller 42 at which time the cable 46 and rotating arm 48 engage over roller 42.

Once rotating arm 48 has engaged over the top of roller 42, continuing tensioning in direction D of cable 46 draws front end 12A of platform 12 up and over roller 42 by the operation of rotating arm 48, better described below.

Once the front end 12A of platform 12 has cleared over the top of roller 42, side rails 18B of subframe 18 engage onto the top of roller 42 and are also drawn in direction D by cable 46 as cable 46 continues to be wound onto the cable take-up 44D of winch 44. The take-up speed of winch 44 is relatively slow, so that the winching process is gentle on the cargo. The on-winching process may take 30 to 60 seconds.

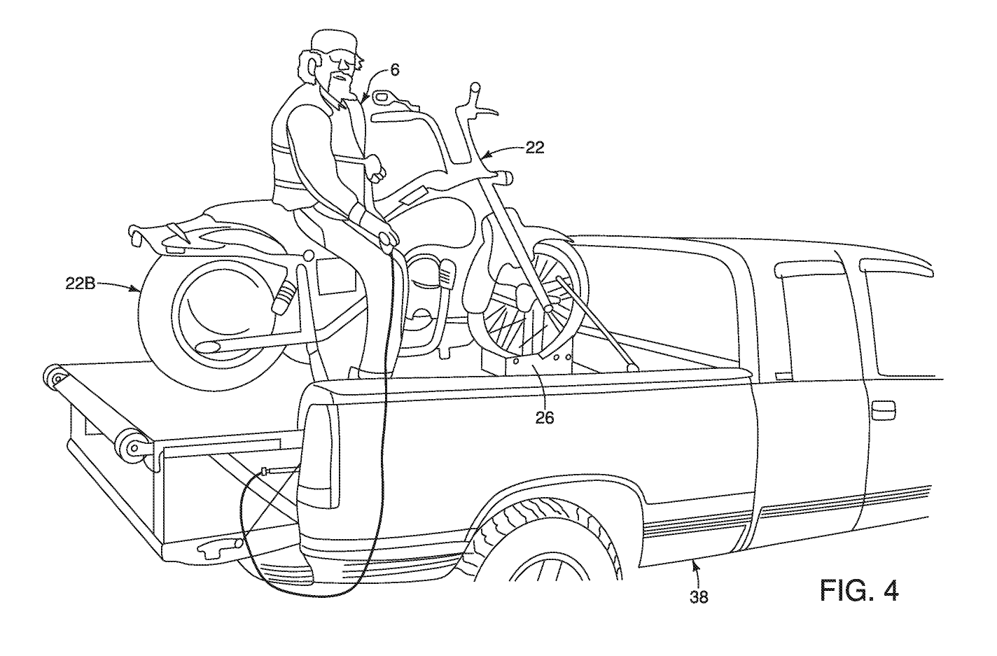

The top of roller 42, as the roller turns passively in direction E due to the frictional engagement of cable 46 over the roller and then the friction engagement of side rails 18B over the roller, bears the increasing weight born by the roller of platform 12 and cargo 20 as the center of gravity 20A of platform 12 and cargo 20 translates up and over the fulcrum formed on roller 42. As the center of gravity 20A passes over roller 42, platform 12 pitches slowly and gently forward in direction F so as to bring the front end 12A of platform 12 down onto the side rails 14A of frame 14. Platform 12 is now horizontal. Continued winching-in of cable 46 draws platform 12 along horizontally on rails 14A so as to position platform 12 and cargo 20 fully onto frame 14 within truck bed 36, as better seen in FIG. 4.

In the illustrated embodiment, not intended to be limiting, the operation of winch 44 may be done remotely by user 6 by use of a controller 44A communicating with winch 44 via cable 44B. Winch 44 may draw its power from battery 44C, which may be located adjacent winch 44 in the front of truck bed 36.

As platform 12 and cargo 20 pass over their fulcrum point on roller 42; that is, as center of gravity 20A passes over roller 42 so as to pitch frame 12 in direction F, the front end 12A of platform 12 relatively slowly and relatively gently lowers so as to engage the lower surfaces 34B of front roller 34 down onto the upper surfaces of side rails 14A. Rollers 34 take up the weight of the front end of cargo 20 and front end 12A, bearing down onto side rails 14A as platform 12 translates forwardly; platform 12 now resting both on roller 42 and front rollers 34 on either side of front end 12A.

In order to unload cargo 20 from its position loaded on platform 12 on top of frame 14, the loading procedure described above is reversed with the exception that, as cable 46 is unwound from winch 44, the user 6 (who happens to be shown in FIGS. 1-3 sitting on motorcycle 22, although this is not intended to be limiting)stands behind the tailgate 36B of truck bed 36 and urges platform 12 rearwardly on rollers 42 and 34 at the same time and rate at which cable 46 is unwound from winch 44. As platform 12 and cargo 20 are pulled rearwardly by user 6, once the center of gravity 20A reaches its fulcrum position above roller 42, platform 12 and cargo 20 begin slowly rocking or pitching backwards, in a direction opposite to direction F. The user 6 may then stop the gentle pulling rearwardly on platform 12 as gravity then takes over, lowering cargo 20 and platform 12 rearwardly without further assistance. The lowering of platform 12 and cargo 20 is resisted by the tension in cable 46. Once rear end 12B of platform 12 is lowered to the ground 8, the rear end 12B translates rearwardly on rollers 32 in a direction opposite to direction C.

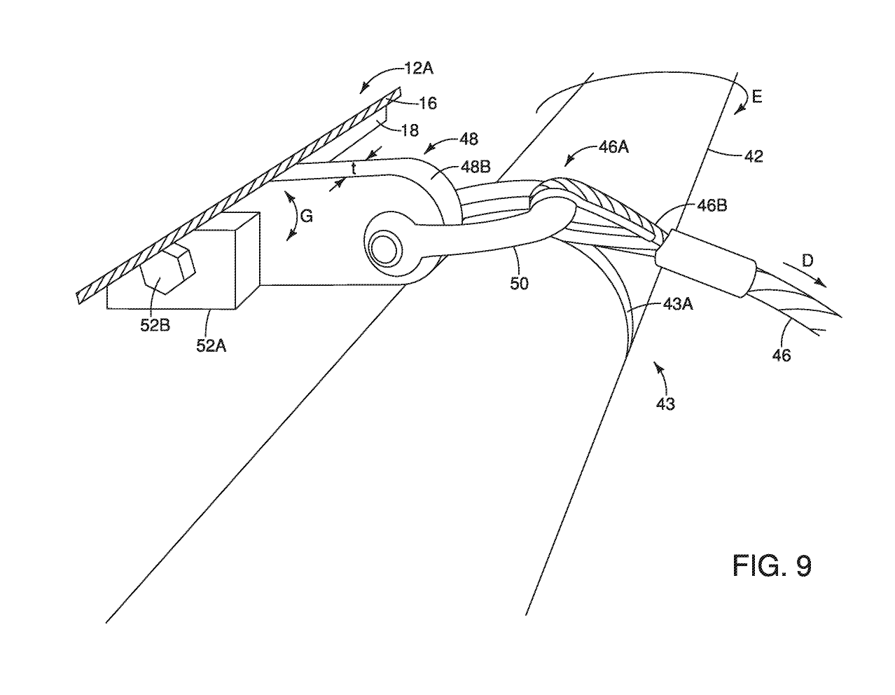

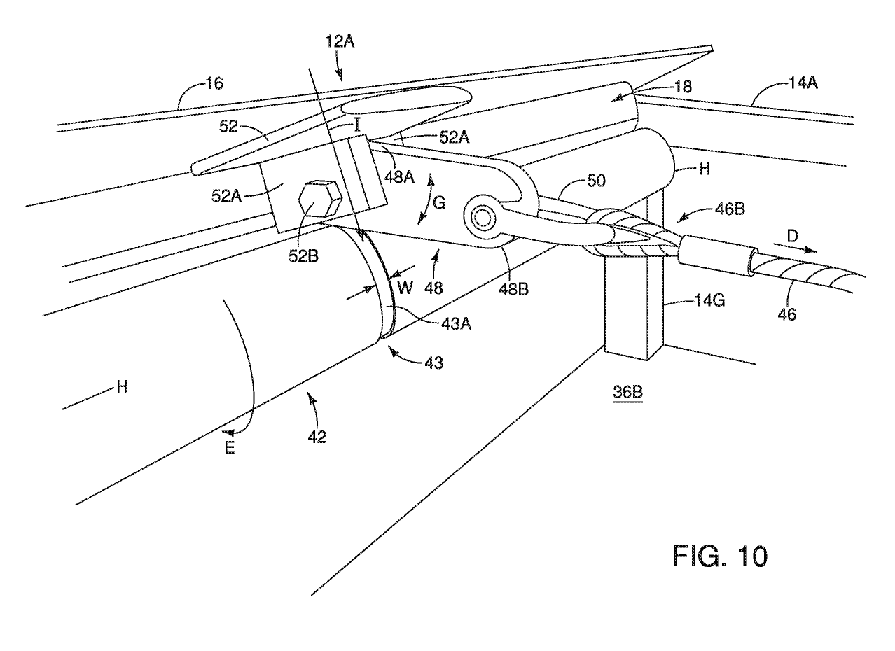

As better seen in the sequence of FIGS. 9 and 10, as the front end 12A of platform 12 is hoisted onto frame 14 by cable 46 tensioned in direction D, as the distal end 46B of cable 46 is pulled clear of the circumferential groove or channel 43A forming cable guide 43 (where cable guide 43 is positioned so as to be centered along the length of roller 42), shackle 50, which is an example of a coupler which couples cable 46 to rotating arm 48, is also pulled over roller 42. This engages the front end 48B of rotating arm 48 against the up-take side 42′ of roller 42. Rotating arm 48 is mounted so as to lie, and rotate in, a substantially vertical plane. Arm 48 is pivotally mounted between mounting brackets 52A which depend downwardly from mounting plate 52. A pair of mounting brackets 52A sandwich rotating arm 48 therebetween. Rotating arm 48 is pivotally mounted by means of, for example, a bolt 52B or for example by means of a shaft or axle or the like. Rotating arm 38 is free to rotate in the vertical plane in direction G. Rotation of rotating arm 48 is constrained in an upward direction by the presence of mounting plate 52 which is mounted to the underside of sheeting 16. Otherwise arm 48 is free to rotate downwardly.

Advantageously, rotating arm 48 has a thickness “t” such that rotating arm 48 is guided into and fits snugly into the width “w” of the channel of cable guide 43 on roller 42 as best seen in FIG. 10.

Thus, with the tension on cable 46 pulling platform 12 in direction D towards a take-up spool 44D on winch 44, rotating arm 48 i s drawn into mating engagement in channel 43A of cable guide 43 on roller 42 as the front end 12A of platform 12 is hoisted into proximity with roller 42.

Platform 12 is then hoisted onto roller 42 as roller 42 turns about its axis of rotation H. Front end 12A is guided and centered by arm 48 engaging channel 43A so that as platform 12 pivots to the horizontal over roller 42, front wheels 34 accurately engage down onto side rails 14A without the side edges 16F of sheeting 16 interfering with the upper edges 36A of truck bed 36. With front end 12A thus centered on roller 42 between upper edges 36A, the lateral width of sheeting 16 may extend out from sub-frame 18 so as to be closely adjacent the sidewalls of the truck box when platform 12 i s mounted on frame 14. Rotating arm 48 thus provides a centering and alignment function. It is an articulated joint having only a single degree of freedom in its movement (its vertical rotation). Arm 48 is otherwise rigidly constrained so as to provide its centering and guiding function for platform 12 to crest the roller 42 during hoisting positioned for accurate loading onto frame 14. Advantageously, rotating arm 48 has a rounded front end 48B which assists in the entry of front end 48B into channel 43A of cable guide 43 on roller 42.

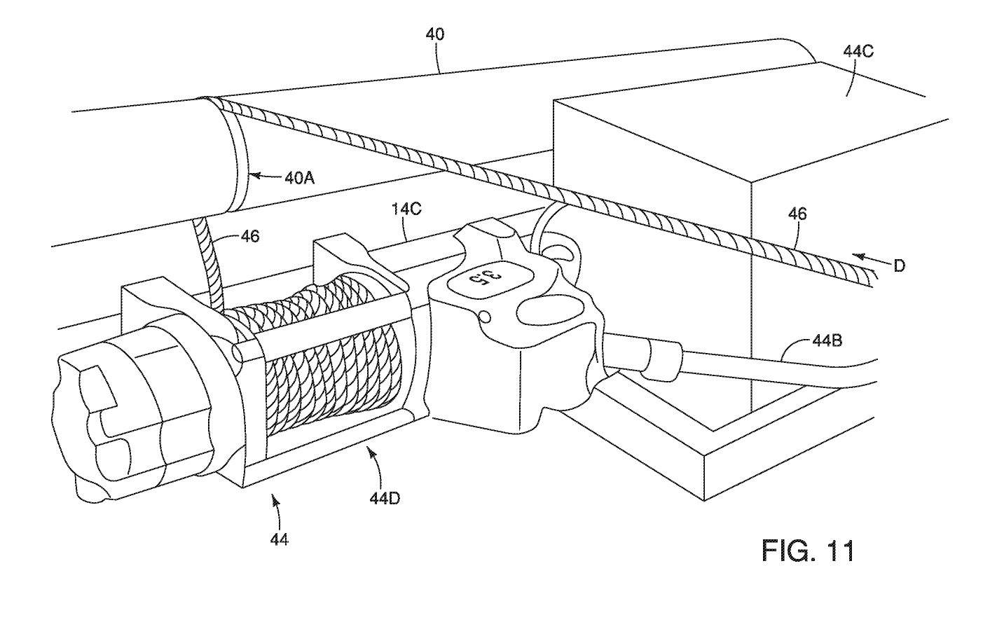

As seen in FIG. 11, cable 46 passes over front roller 40, preferably around a front channel guide 40A on roller 40, so as to be taken up onto spool 44B on winch 44. In one embodiment as illustrated, a battery 44C may be mounted adjacent to winch 44. Winch 44 may be mounted to the front cross member 14C on frame 14.

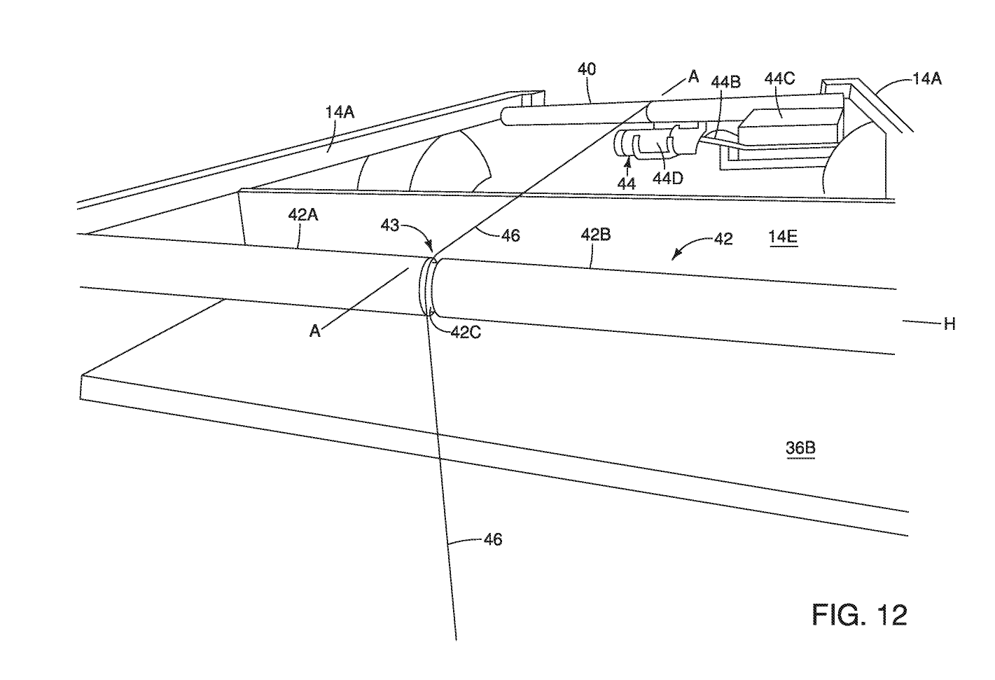

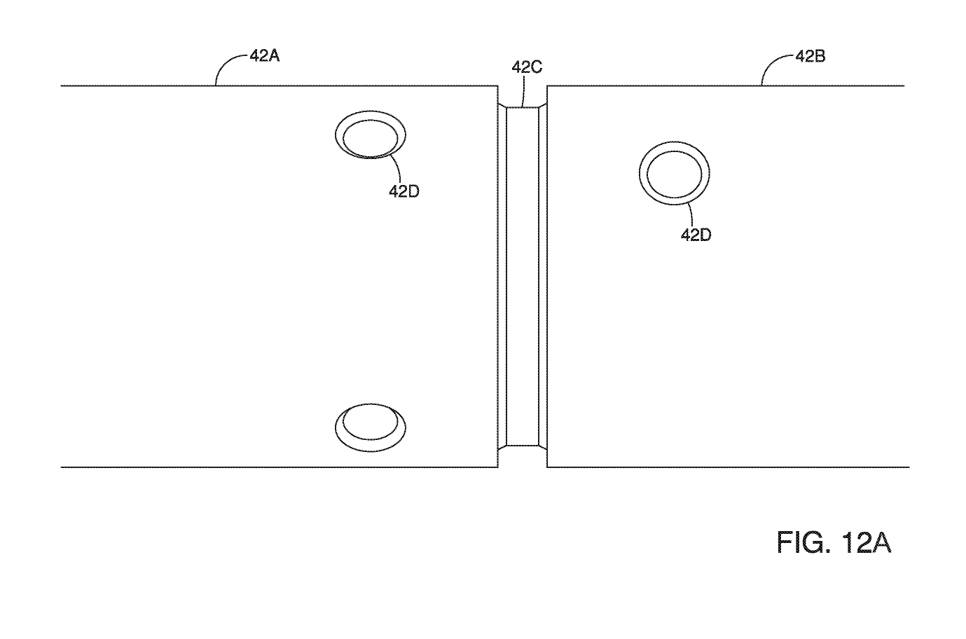

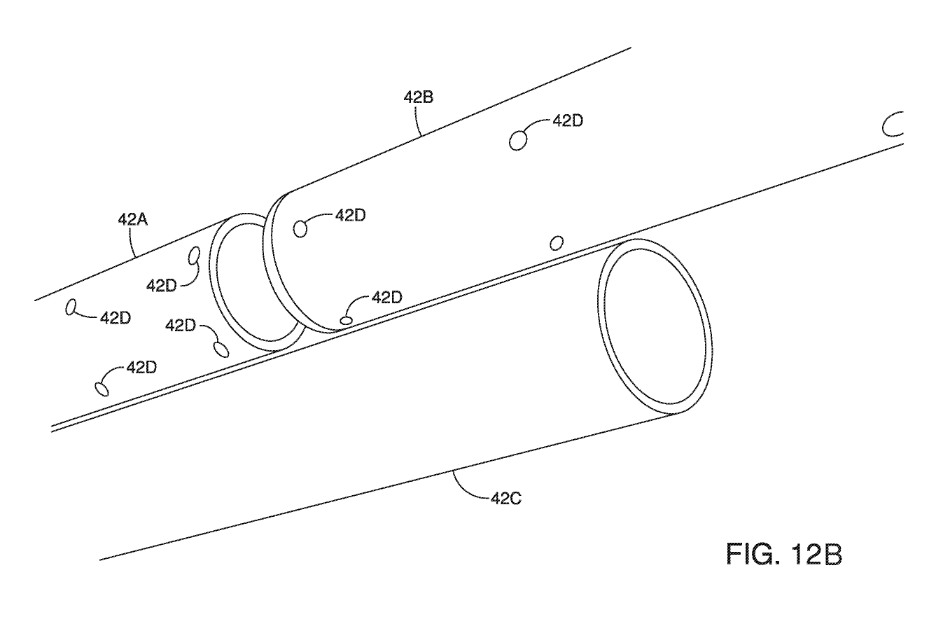

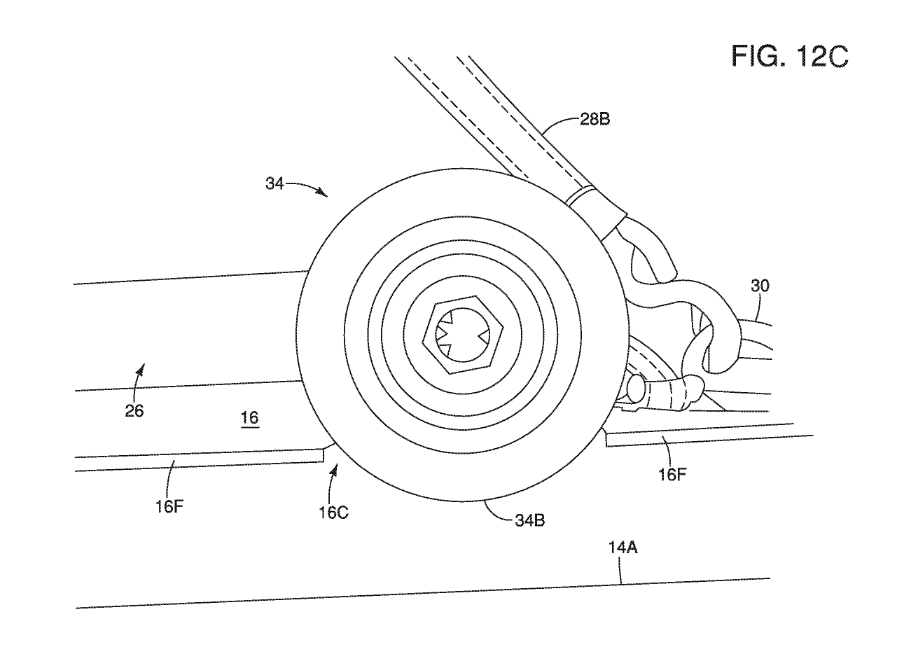

FIG. 12 illustrates the orientation of the channel guides 40A, 43 on front and rear rollers 40, 42, respectively as cable 46 runs from front to back along centroidal axis A. The cable guides serve to align cable 46 along axis A independently of where cable 46 is being taken up along the length of take-up spool 44D on winch 44.

It will be understood by one skilled in the art that during hoisting of platform 12 onto and over roller 42, that the entire weight load, combined with the tension on cable 46 exerted by winch 44, acts with a force vector I in a downward and forward direction. The force vector I is of varying magnitude and direction, concentrated on the center of roller 42, orthogonal to roller axis H. In particular, force vector I is concentrated on cable guide 43 as arm 48 i s passing thereover, and thus applicant has found it advantageous to reinforce roller 42 with an integrated design in integrating the cable guide into the roller. Thus, in a preferred embodiment, not intended to be limiting, as seen in FIGS. 12A and 12B, roller 42 may be formed of left and right roller sleeves 42A and 42B respectively which extend laterally along axis H away from axis A on either side of cable guide 43. Channel 42A of cable guide 43 is formed by the reinforcing tube 42C snugly journaled into the opposed facing ends of sleeves 42A and 42B and secured therein by means of fasteners 42D so as to leave a gap of width “w” between the ends of the sleeves. The nesting of tube 42C into the opposed facing ends of sleeves 42A and 42B has been found by applicants to provide a reinforced roller structure which resists bending due to force vector I as platform 12 carrying cargo 20 is hoisted up and onto the roller 42.

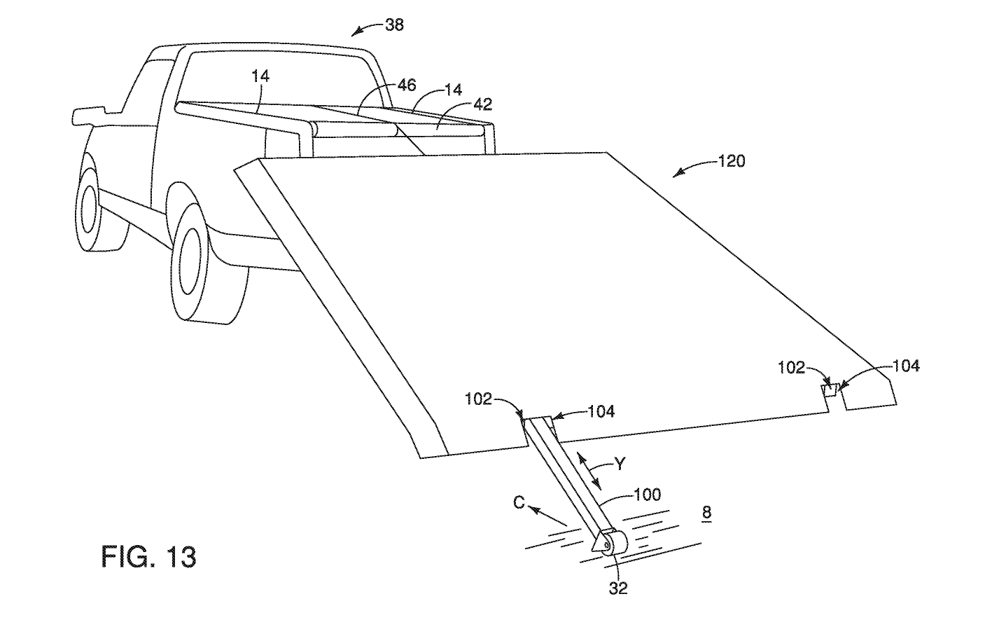

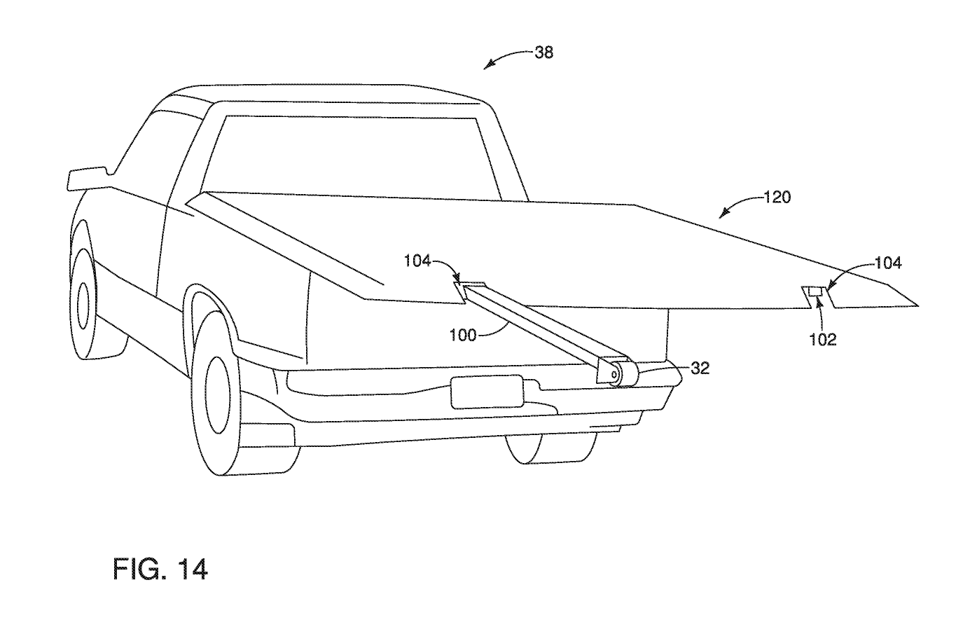

In the alternative, top-loader embodiment of FIGS. 13 and 14, platform 120 i s wider than platform 12 in the mid-loader embodiment of FIGS. 1-4. As seen in FIG. 14, platform 120 sits above the box of truck 38 when resting on frame 14. Frame 14 in the top-loader embodiment thus extends higher than in the mid-loader embodiment so the platform 120 may clear over the walls of the truck bed during hoisting and once fully hoisted. Platform 120 thus may accommodate different, wider, loads than platform 12. For example a pair of ATVs or snowmobiles may be mounted side-by-side on platform 120. The hoisting up and down of platform 120 remains the same as described above for the mid-loader embodiment hoisting platform 12.

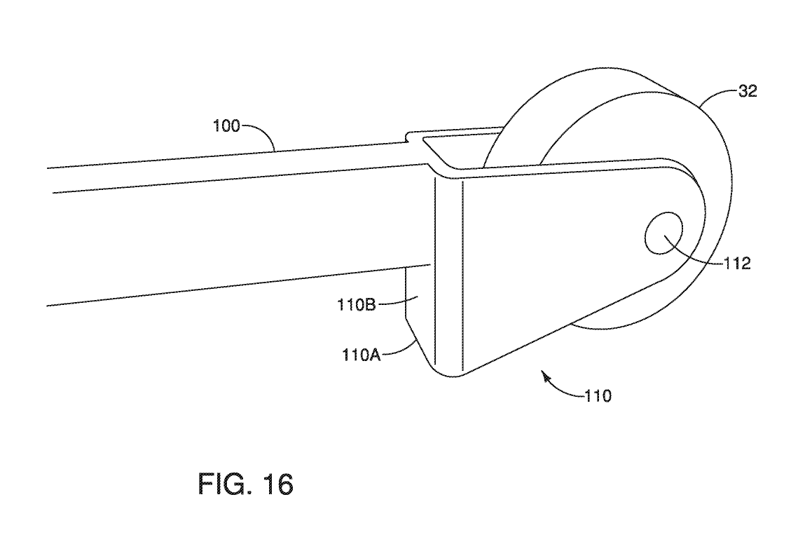

As seen in FIGS. 13-16, a pair of extendable legs 100, only one of which is illustrated, are telescopically mounted in or under platform 12 or 120 i n the mid-loader or top-loader embodiments, respectively. Legs 100 are snugly slidably mounted in correspondingly shaped receiver tubes or sleeves 102 which are rigidly mounted in or under platform 12 or 120, for example to sub-frame 18. Legs 100 telescopically extend or retract in direction Y through the pair of apertures 104 in the trailing edge of platform 12 or 120. Legs 100 are laterally spaced apart for stability of the platform.

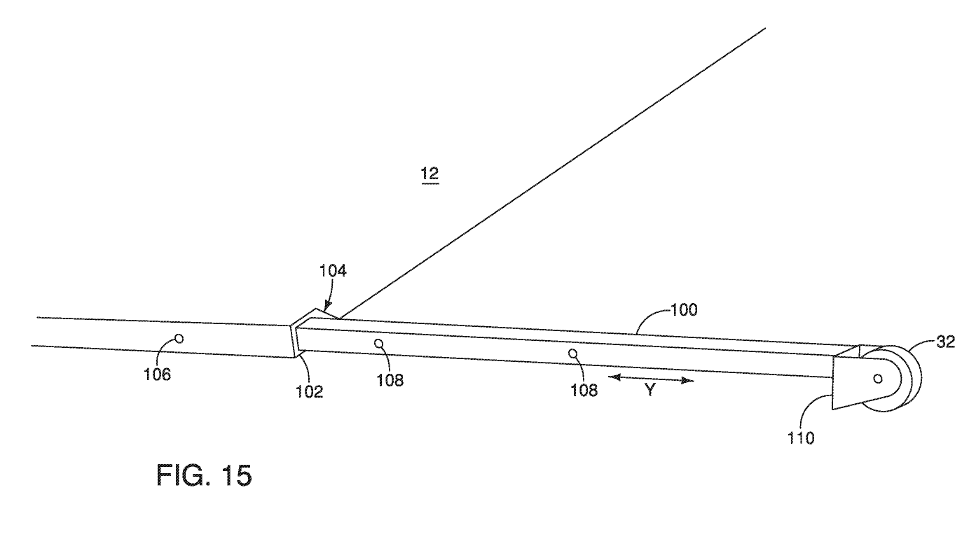

Legs 100 may be maintained in their extended or retracted positions by means of latches or the like known in the art, for example by means of pins (not shown) journalled through hole 106 in tubes 102 when aligned with a selected hole of the series of holes 108 along legs 100; as best seen in FIG. 15.

The use of legs 100, when extended, reduces the included angle platform 12 or 120 forms relative to the horizontal during hoisting. The reduced included angle reduces the stresses on tie-downs and the like restraining a load on top of the platform, and the load will be more stable during hoisting. Legs 100 effectively lengthen platform 12 or 120 for the purpose of decreasing the included angle of the platform during hoisting as wheels 32 roll in direction C. Once the platform 12 or 120 is fully hoisted to the horizontal on top of frame 14, or when the platform is flush on the ground 8, legs 100 may be retracted into receiver tubes 102 so as to be conveniently out of the way.

Wheels 32 are mounted in U-brackets 110 so as to rotate on pins or shafts 112. The forward, lower edge 11a is formed as part of a flange 110b protruding downwardly from leg 100. This flange serves as an anchor or brake when platform 12 or 120 is horizontal, or close to horizontal. When the angle between the platform and the ground 8 is small, the flange 110b engages the ground 8 and wheel 32 dis-engages from contact with the ground.

In one embodiment, the loader 10 may be modular or the larger components, for example the platform 12 or 120, maybe be foldable or otherwise collapsible to reduce the size for shipping. In order to reduce weight, for example the rollers (e.g. roller 42), may be made of aluminum. Other components may also be similarly reduced in weight. For ease of use, a quick attach/detach system may be provided for attaching and detaching the frame 14 in the truck bed.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed:

1. An apparatus to load cargo onto the bed of a truck comprising;
a frame mountable onto the bed of the truck,
a platform having forward and rear wheels depending downwardly from corresponding front and rear ends thereof,
a winch having a winch cable wherein the winch is mountable to the frame and the cable is extendable from the winch,
a rear roller mounted on a rear end of the frame, a cable guide cooperating with the rear roller,
wherein the platform is positionable into a pre-hoisting position at the rear of the frame so as to be aligned with the frame when mounted in the bed of the truck,
and wherein the winch cable is selectively extendable from the winch, over the cable guide and r ear roller, and to the front end o f the platform when in the pre-hoisting position, wherein a distal end of the cable, distal from the winch, is removably mountable to the front end of the platform,
wherein the front end of the platform is hoistable from its pre-hoisting position onto the rear roller where-upon continued winching in of the cable onto the winch draws the rest of the platform over the rear roller,
wherein the platform and any cargo thereon have a center-of-gravity, and wherein the platform pivots over the roller, wherein the roller provides a fulcrum, as the center-of-gravity is drawn over the roller past a balance point of the platform and cargo so that the platform pitches from an inclined-during-hoisting position to a horizontal and loaded position with the front wheels resting on the frame and the platform completely on the frame.

2. The apparatus of claim 1 wherein the cable guide is formed as a circumferential guide channel around the roller and positioned substantially centred along a length of the roller.

3. The apparatus of claim 2 further comprising a locating arm mounted under a leading edge of the platform, the locating arm rotatably mounted to the platform for rotation of the arm in only a vertical plane, the arm adapted to be coupled to an end of the winch cable and sized to mate into the cable guide.

4. The apparatus of claim 3 wherein the arm is a vertically oriented plate.

5. The apparatus of claim 1 wherein the platform has a weight which, including the weight of any cargo on the platform, is fully supported on the wheels when the platform has been winched up onto, so as to be mounted on the frame, or when the platform is fully resting on the ground.

6. The apparatus of claim 5 wherein the rear wheels include rear wheel brakes mounted at a rear end of the platform.

7. The apparatus of claim 6 further comprising rearwardly extendable telescopic legs mounted to the platform, and wherein the rear wheels are mounted on rearmost ends of the telescopic legs.

8. The apparatus of claim 7 wherein the rear wheel brakes include downwardly depending flanges which depend downwardly in front of the rear wheels so as to engage a ground surface during hoisting of the platform when an included angle between the platform and the ground is such that the flanges engage the ground and disengage the wheels from the ground.

9. The apparatus of claim 7 wherein the telescopic legs include a pair of laterally spaced apart legs spaced laterally on the rear end of the platform.

10. The apparatus of claim 5 wherein the platform is mid-loader platform and the frame is a mid-loader frame, and wherein the mid-loader platform and frame are adapted and sized for mounting into and within a walled bed of a pickup truck.

11. The apparatus of claim 5 wherein the platform is a top-loader platform and the frame is a top-loader frame, and wherein the top-loader frame is adapted and sized for mounting the top-loader platform on top of the walls of a pickup truck bed and the top-loader platform extends laterally beyond the walls of the pickup truck bed when mounted on the frame.

12. The apparatus of claim 2 wherein the rear roller is formed as an inner cylinder nested in a pair of opposed facing outer cylinders, wherein opposed facing ends of the opposed facing outer cylinders are spaced apart to form the guide channel as an annular guide channel therebetween around the inner cylinder.

13. The apparatus of claim 2 further comprising a front roller mounted on a front end of the frame.

14. The apparatus of claim 5 wherein the rear wheels extend downwardly of the platform sufficiently to provide for forward and rearward translation of the platform on the ground, with only the rear wheels in contact with the ground, during hoisting and lowering of the platform in it's inclined-during hoisting position between the platform's pre-hoisting position on the ground and the loaded position on the fr
